(19) United States
(12) Patent Application Publication
(10) Pub. No.: US 2023/0188086 A1
(43) Pub. Date: Jun. 15, 2023

(54) MOUNTING BRACKETS AND ASSOCIATED METHODS FOR SECURING SOLAR MODULES OF SOLAR ARRAYS

(71) Applicant: National Oilwell Varco, L.P., Houston, TX (US)

(72) Inventors: Julio Cesar Garza, Houston, TX (US); Adam Kim, Edmonton (CA); Mitchell Benson, Houston, TX (US); Travis Miller, Houston, TX (US); Milos Stancic, Houston, TX (US)

(73) Assignee: National Oilwell Varco, L.P., Houston, TX (US)

(21) Appl. No.: 18/078,756

(22) Filed: Dec. 9, 2022

Related U.S. Application Data
(60) Provisional application No. 63/287,778, filed on Dec. 9, 2021.

(51) Int. Cl. H02S 20/32; H02S 30/10

(52) U.S. Cl. CPC H02S 20/32; H02S 30/10

(57) ABSTRACT

A mounting bracket for a solar array includes a top hat assembly including an outer top hat having a longitudinally extending first rail configured to contact a solar module of the solar array, and an inner top having a longitudinally extending second rail also configured to contact the solar module, an actuator arm assembly comprising a pair of actuator arms which extend from the top hat assembly and which form an opening configured to receive a tubular member of the solar array, and a fastener assembly configured to connect the pair of actuator arms and secure the mounting bracket to both the solar module and the tubular member.

### CROSS-REFERENCE TO RELATED APPLICATIONS

The present application claims benefit of U.S. provisional patent application No. 63/287,778 filed Dec. 9, 2021, and entitled “Mounting Brackets and Associated Methods for Securing Solar Modules of Solar Arrays” which is incorporated herein by reference in its entirety.

### STATEMENT REGARDING FEDERALLY SPONSORED RESEARCH OR DEVELOPMENT

Not applicable.

### BACKGROUND

Photovoltaic (PV) systems absorb sunlight to generate electrical power which may be utilized for a variety of purposes. PV systems may include, among other components, one or more solar arrays including multiple solar panels which may also be referred to herein as solar or PV modules. Each solar module may incorporate a plurality of solar cells into a single structure, where each solar cell converts sunlight into electrical power such as direct current (DC) electrical power. The electrical power generated by the solar modules of the solar array may feed into an electrical grid or may be consumed directly by a user of the solar array. The solar array may additionally include a support structure used to secure each solar module of the solar array into a desired position. In some applications, the support structure of the solar array may manipulate the position of one or more of the solar modules so as to maximize the production of electrical power from the solar modules of the array.

### SUMMARY

An embodiment of a mounting bracket for a solar array comprises a top hat assembly comprising a longitudinal axis, a lateral axis orthogonal the longitudinal axis, an outer top hat having a longitudinally extending first rail configured to contact a solar module of the solar array, and an inner top hat having a longitudinally extending second rail also configured to contact the solar module, an actuator arm assembly comprising a pair of actuator arms which extend from the top hat assembly and which form an opening configured to receive a tubular member of the solar array, and a fastener assembly configured to connect the pair of actuator arms and secure the mounting bracket to both the solar module and the tubular member, wherein the fastener assembly comprises a first fastener extending from a first actuator arm of the pair of actuator arms and a second fastener positioned in a second actuator arm of the pair actuator arms, and wherein at least one of the first fastener and the second fastener is rotatable about a longitudinal axis of the first fastener when the first fastener is connected to the second fastener, wherein the fastener assembly comprises an unlocked configuration permitting access to the opening, and a locked configuration which encloses the opening. In some embodiments, each of the pair of actuator arms are pivotally coupled to the top hat assembly. In some embodiments, relative movement along the lateral axis of the top hat assembly between the inner top hat and the pair of actuator arms is restricted. In certain embodiments, a predefined degree of relative movement along the lateral axis of the top hat assembly between the outer top hat and the pair of actuator arms is permitted. In certain embodiments, the first rail comprises a first contact surface configured to contact a first surface of the solar module, and the second rail comprises a second contact surface configured to contact an opposing second surface of the solar module, and the first contact surface comprises a first edge formed thereon and configured to pierce the first surface of the solar module. In some embodiments, the first contact surface and the second contact surface are each electrically conductive. In some embodiments, the mounting bracket comprises a plurality of mounts including a first pair of mounts coupled to the top hat assembly and a second pair of mounts coupled to the pair of actuator arms. In some embodiments, each of the plurality of mounts comprises a contact surface which extends at an acute or obtuse angle relative to the longitudinal axis of the top hat assembly. In certain embodiments, the outer top hat comprises a pair of the first rails and the inner top hat comprises a pair of the second rails.

An embodiment of a solar array for producing electrical power from sunlight comprises a solar module comprising one or more solar cells, a support structure comprising a tubular member for supporting the solar module, and a mounting bracket for locking the solar module to the tubular member of the support structure, the mounting bracket comprising a top hat assembly comprising a longitudinal axis, a lateral axis orthogonal the longitudinal axis, an outer top hat having a longitudinally extending first rail configured to contact a solar module of the solar array, and an inner top hat having a longitudinally extending second rail also configured to contact the solar module, an actuator arm assembly comprising a pair of actuator arms which extend from the top hat assembly and which form an opening configured to receive a tubular member of the solar array, and a fastener assembly comprising a first fastener and a second fastener and configured to connect the pair of actuator arms and secure the mounting bracket to both the solar module and the tubular member, wherein the fastener assembly comprises an unlocked configuration in which the first fastener is disconnected from the second fastener and the tubular member is permitted to enter into the opening, and a locked configuration which locks the solar module to the mounting bracket and the mounting bracket to the tubular member received in the opening in response to only mechanically connecting the first fastener to the second fastener when the tubular member is received in the opening and the solar module is received in an aperture formed between the first rail and the second rail. In some embodiments, at least one of the first fastener and the second fastener is rotatable about a longitudinal axis of the first fastener when the first fastener is connected to the second fastener. In some embodiments, the solar module is electrically grounded to the support structure when the fastener assembly is in the locked configuration with the tubular member received in the opening and the solar module received in the aperture. In certain embodiments, the first fastener is configured to displace the inner top hat relative to the outer top hat along the lateral axis when the tubular member is received in the opening in response to applying a rotational torque to one of the first fastener and the second fastener. In certain embodiments, each of the pair of actuator arms of the mounting bracket are pivotally coupled to the top hat assembly. In some embodiments, relative movement along the lateral axis of the top hat assembly of the mounting bracket between the inner top hat and the pair of actuator arms is restricted, and a predefined degree of relative movement along the lateral axis of the top hat assembly between the outer top hat and the pair of actuator arms is permitted. In some embodiments, the first rail of the mounting bracket comprises a first contact surface configured to contact a first surface of the solar module, and the second rail comprises a second contact surface configured to contact an opposing second surface of the solar module, and the first contact surface comprises a first edge formed thereon and configured to pierce the first surface of the solar module. In some embodiments, the first contact surface and the second contact surface of the mounting bracket are each electrically conductive.

In some embodiments, the mounting bracket includes a lower mount including sliding pin assemblies, wherein the actuator arms include angled slot openings to receive the sliding pin assemblies, and wherein the fastener assembly comprises a connector rod coupled between ends of the actuator arms and the connector rod is rotatable to move the ends of the actuator arms and thereby cause the sliding pin assemblies to slide in the angled slot openings such that the lower mount moves relative to the actuator arms. In some embodiments, the angles of the angled slot openings are adjustable to accommodate different types or sizes of torque tubes or solar modules, or different compressive forces needed for locking.

An embodiment of a method for coupling a solar module of a solar array to a support structure of the solar array comprises (a) inserting a tubular member of the support structure into an opening formed between a pair of actuator arms of an actuator arm assembly of the mounting bracket (b) inserting the solar module into an aperture formed between an outer top hat and an inner top hot of a top hat assembly of the mounting bracket, and (c) mechanically connecting only a first fastener with a second fastener of a fastener assembly of the mounting bracket whereby the inner top hat is displaced relative to the outer top hat along a lateral axis of the top hat assembly to both lock the top hat assembly to the solar module and lock the pair of actuator arms to the tubular member received in the opening. In some embodiments, (c) comprises forming an electrical connection between the support structure and the solar array through the mounting bracket. In some embodiments, (c) comprises applying a rotational torque to at least one of the first fastener and the second fastener to rotate at least one of the first fastener and the second fastener about a longitudinal axis of the first fastener.

### BRIEF DESCRIPTION OF THE DRAWINGS

For a detailed description of exemplary embodiments of the disclosure, reference will now be made to the accompanying drawings in which:

FIG. 1 is a perspective view of an embodiment of a PV system;

FIGS. 2, 3 are zoomed-in, perspective views of the PV system of FIG. 1;

FIG. 4 is a perspective view of an embodiment of a mounting bracket of the PV system of FIG. 1;

FIG. 5 is a front view of the mounting bracket of FIG. 4;

FIG. 6 is a side view of the mounting bracket of FIG. 4;

FIG. 7 is a front view of an embodiment of a top hat assembly of the mounting bracket of FIG. 4;

FIGS. 8-11 are front views of the mounting bracket of FIG. 4;

FIG. 12 is a flowchart of an embodiment of a method for coupling a solar module of a solar array to a support structure of the solar array;

FIG. 13 is a perspective view of another embodiment of a mounting bracket of the PV system of FIG. 1;

FIG. 14 is a front view of the mounting bracket of FIG. 13;

FIG. 15 is a side view of the mounting bracket of FIG. 13; and

FIG. 16 is a perspective, exploded view of the mounting bracket of FIG. 13.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. Any reference to “up,” “upper,” “upwardly,” “down,” “lower,” “downwardly” and the like in the description and the claims is made for purposes of clarity.

As described above, PV systems may include one or more solar arrays including a support structure and a plurality of solar modules supported by the support structure. In some applications, the support structure of a given solar array may include one or more rotatable shafts or members sometimes referred to as torque tube. The plurality of solar modules of the solar array may each be mounted to the torque tubes thereof such that the solar modules may be positioned in a desired orientation relative to the sun. The orientation of the solar modules may be conveniently adjusted relative to the sun by rotating the torque tube to thereby maximize the production of electrical power from the solar modules of the solar array.

In some applications, a solar array may include thousands of individual solar modules. Each solar module may also be individually mounted to the support structure of the solar array. For example, each solar module may be mounted to a torque tube or other member of the support structure by one or more clamps or mounting brackets. It may be necessary to manually assemble the solar modules with the support structure of the solar array at the location at which the solar array is to be installed. The process of manually assembling a large number of solar modules with the support structure of the solar array may be significantly labor intensive and time-consuming process and thus substantially add to the overall costs associated with installing the solar array. For example, for each solar module one or more mounting brackets may be manually coupled to both the solar module and to the torque tube or other components of the support structure to which the mounting brackets attach. Coupling each mounting bracket to a given solar module and the torque tube may require manually coupling a plurality of fasteners of the mounting bracket to secure the solar module coupled therewith into position. Repeated over a large number (e.g., thousands) of mounting brackets, coupling a plurality of fasteners for each mounting bracket may add substantial time to that required for assembling the entire solar array.

Accordingly, embodiments of mounting brackets for solar arrays are disclosed herein which require only a single mechanical connection to be made at the installation site (e.g., the site at which the solar array is to be assembled) to thereby couple the mounting bracket to both a solar module and a support structure of the solar array. Particularly, making the single mechanical connection concurrently locks both the solar module to the mounting bracket and locks the mounting bracket to the support structure such that relative movement between the solar module and the component of the support structure to which the mounting bracket contacts is restricted. Additionally, the making of the single mechanical connection of the mounting bracket may also electrically ground the solar module to the support structure through the mounting bracket. By requiring only a single mechanical connection to be made when assembling the mounting bracket with the solar module and support structure of the solar array minimizes the time required for assembling the solar module with the support structure. Given that a solar array may include thousands of solar modules and corresponding mounting brackets, minimizing the time required for assembling each solar module with each mounting bracket may result in substantial time savings for installing the solar array, in-turn substantially reducing the costs (e.g., labor and other costs) associated with installing the solar array.

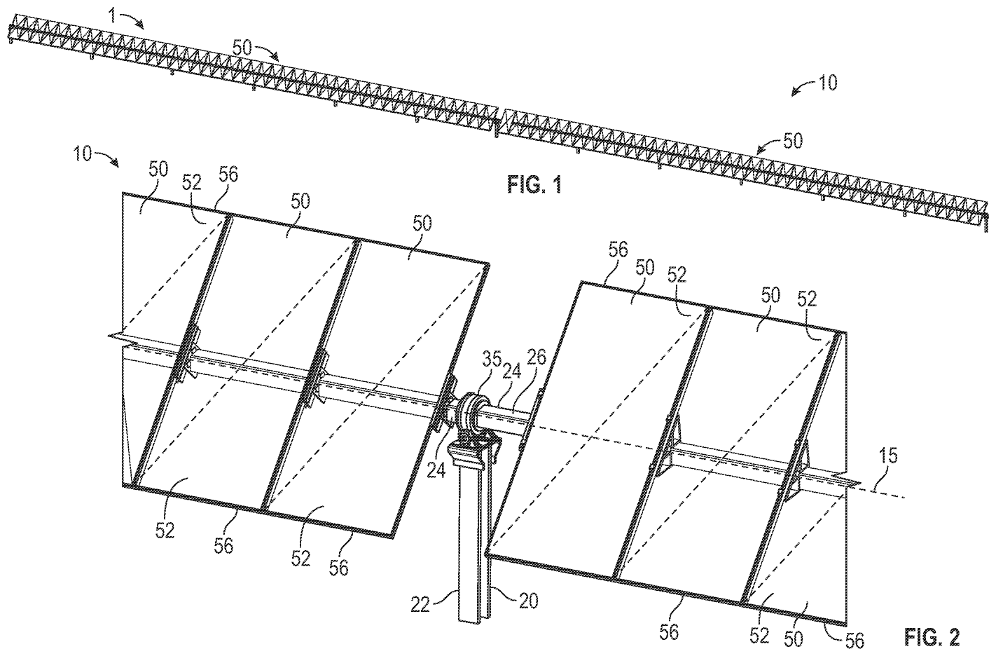

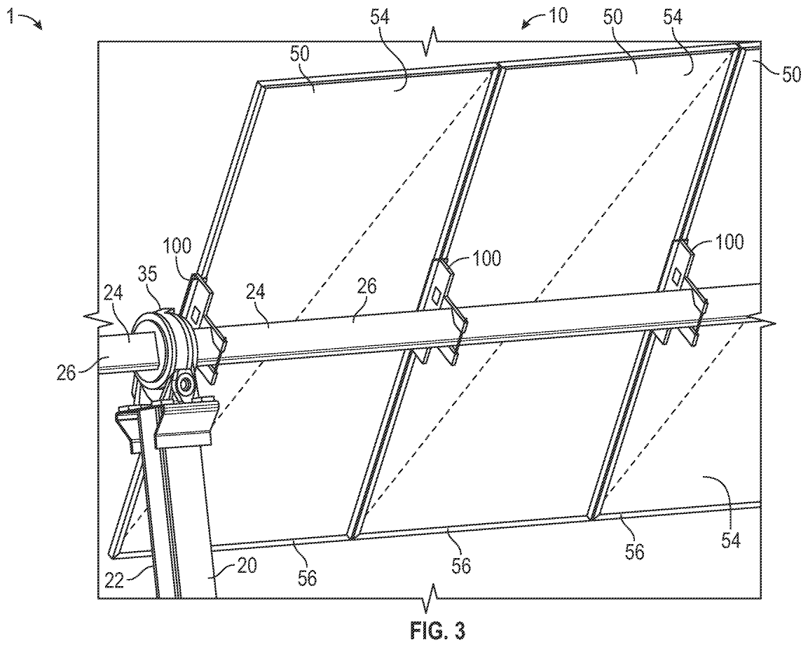

Referring now to FIGS. 1-3, an embodiment of a PV system 1 is shown for producing electrical power from sunlight. In this exemplary embodiment, PV system 1 includes a solar array 10. In some embodiments, PV system 1 may include features in addition to the solar array 10 shown in FIGS. 1-3 such as, for example, batteries, electrical power storage equipment, electrical power distribution equipment, etc. Additionally, PV system 1 may comprise more than one solar array 10 and/or additional solar arrays which vary in configuration from solar array 10.

In this exemplary embodiment, solar array 10 generally includes a support structure 20, a plurality of solar modules 50, and a plurality of clamps or mounting brackets 100 which attach the solar modules 50 to the support structure 20 of solar array 10. Support structure 20 of solar array 10 supports the solar modules 50 and positions the solar modules 50 in a desired orientation relative to the horizon. In this exemplary embodiment, support structure 20 may rotate or pivot the solar modules 50 so as to adjust their orientation relative to the horizon in the interest of maximizing the production of electrical power from solar array 10.

In this exemplary embodiment, support structure 20 of solar array 10 generally includes a plurality of vertically extending support beams or members 22, a plurality of rotatable members or torque tubes 24, and a drive motor 35. In some embodiments, support structure 20 may be configured differently and may include features not shown in FIGS. 1-3. The support beams 22 of support structure 20 may transfer or react loads to the ground and locate the solar modules 50 in a position vertically above the ground. Particularly, in this exemplary embodiment, torque tubes 24 are connected end-to-end extending from the drive motor 35. In this exemplary embodiment, each torque tube 24 comprises an outer surface 26 defined by a plurality of planar surfaces or faces which form a square cross-section; however, it may be understood that in other embodiments the shape, including the cross-sectional shape, of torque tubes 24 may vary.

The drive motor 35 of support structure 20 is located atop of at least some of the support beams 22 and are each configured to selectably apply a rotational torque to the torque tubes 24 of support structure 20. Particularly, torque tubes 24 are connected to the drive motor 35 which is configured to selectably rotate torque tubes 24 about a rotational axis 15 of solar array 10 which extends horizontally relative to the ground. Additionally, through the connection formed between solar modules 50 and torque tubes 24 via mounting brackets 100, drive motor 35 is configured to selectably rotate solar modules 50 about the rotational axis 15 in concert with torque tubes 24. In this exemplary embodiment, the rotational axis 15 is concentric with a longitudinal axis of each torque tube 24; however, in other embodiments, the axes of torque tubes 24 may be offset from rotational axis 15. In still other embodiments, solar array 10 may not include drive motor 35 and instead solar modules 50 may remain stationary relative to the ground.

The solar modules 50 of solar array 10 each comprise a plurality of solar cells which convert sunlight received by the solar module 50 into electrical power which is captured by the PV system 1. Thus, solar modules 50 may also be referred to herein as PV modules 50. In this exemplary embodiment, each solar module 50 is planar and generally rectangular in shape having a planar upper surface 52 (exposed to sunlight), a planar lower surface 54, and a rectangular outer frame 56 which defines an outer periphery of the solar module 50. It may be understood that in other embodiments the shape of solar modules 50 may vary from that shown in FIGS. 1-3.

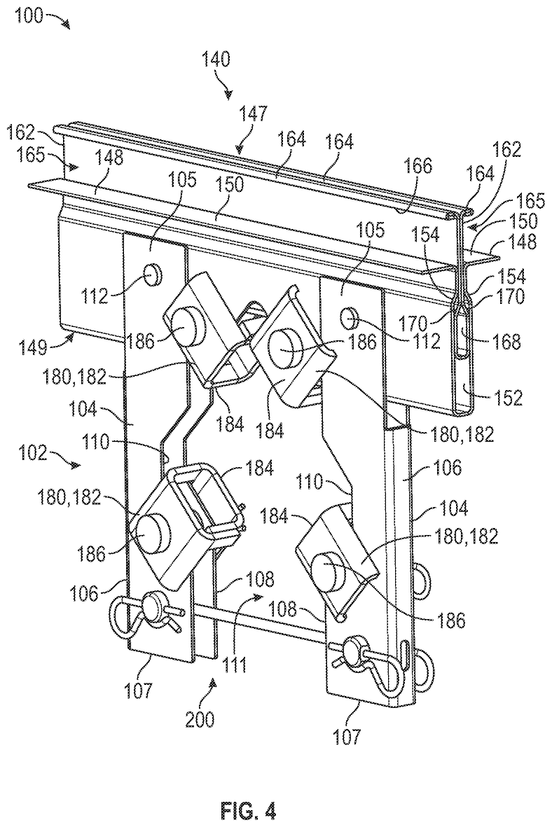

Referring now to FIGS. 4-7, additional views of one of the mounting brackets 100 of solar array 10 are shown. It may be understood that while in this embodiment mounting brackets 100 are incorporated into solar array 10 and PV system 1, in other embodiments, mounting brackets 100 may be incorporated into solar arrays and/or PV systems which vary in configuration from solar array 10 and PV system 1. As described above, mounting brackets 100 connect or secure the solar modules 50 to the support structure 20 of solar array 10. Particularly, in this exemplary embodiment, mounting brackets 100 directly connect the solar modules 50 to the torque tubes 24 of support structure. Additionally, as will be discussed further herein, mounting brackets 100 electrically ground the solar modules 50 to the support structure 20 of solar array 10.

In this exemplary embodiment, mounting bracket 100 generally includes an actuator arm assembly 102, a top hat assembly 140, a plurality of mounts 180, and a fastener assembly 200. As will be discussed further herein, actuator arm assembly 102 in conjunction with mounts 180 and fastener assembly 200 secures mounting bracket 100 to one of the torque tubes 24 of support structure 20 while the top hat assembly 140 secures the mounting bracket 100 to one or more solar modules 50. In this exemplary embodiment, the components of actuator arm assembly 102, top hat assembly 140, mounts 180, and/or fastener assembly 200 are formed from an electrically conductive material such that mounting bracket 100 may electrically connect one or more solar modules 50 to the support structure 20 of solar array 10 to thereby ground the one or more solar modules 50 to the support structure 20. For example, in some embodiments, the actuator arm assembly 102, top hat assembly 140, mounts 180, and/or fastener assembly are formed from galvanized steel; however, in other embodiments, the materials from which the components of mounting bracket 100 are formed may vary.

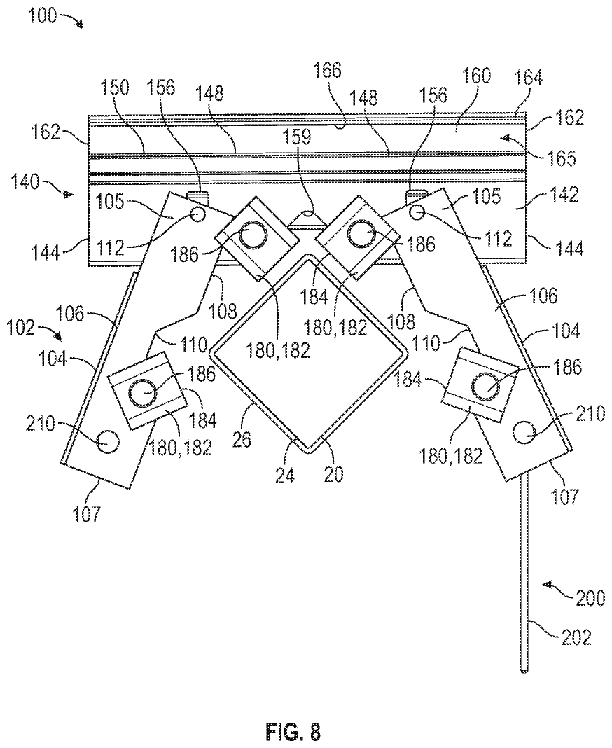

In this exemplary embodiment, actuator arm assembly 102 comprises a pair of opposed actuator arms 104 each extending between a longitudinal first end 105 and a longitudinal second end 107 opposite the first end 105. Additionally, each actuator arm 104 has an outer lateral side 106 and an inner lateral side 108 opposite the outer lateral side 106. In this exemplary embodiment, a recess 110 is formed in the inner lateral side 108 of each actuator arm 104. Additionally, each actuator arm 104 is pivotably coupled to the top hat assembly 140 of mounting bracket 100 by a pivot joint 112 which extends through the first end 105 of the respective actuator arm 104. In this configuration, each actuator arm 104 may pivot about a rotational axis 113 (orthogonal a longitudinal axis 141 of the top hat assembly 140 and extending centrally through the particular actuator arm 104) between an enclosed position (shown in FIGS. 4-7) and an open position (shown in FIG. 8). Extending from top hat assembly 140, actuator arms 104 form an opening 111 configured to securely receive a torque tube 24 of the support structure 20 of solar array 10.

The top hat assembly 140 of mounting bracket 100 is configured to contact and grip one or more solar modules 50 to thereby secure the one or more solar modules 50 to the mounting bracket 100. In this exemplary embodiment, top hat assembly 140 generally includes an outer top hat 142 and an inner top hat 160 that is slidably positioned in the outer top hat 142. Additionally, top hat assembly 140 includes the longitudinal axis 141 (not necessarily a central axis of top hat assembly 140) and a lateral axis 143 which extends orthogonally to longitudinal axis 141. Further, top hat assembly 140 has a first or outer side 147 distal actuator arm assembly 102 and a second or inner side 149, opposite outer side 147 along lateral axis 143, proximal actuator arm assembly 102.

In this exemplary embodiment, the outer top hat 142 has a pair of opposed longitudinal ends 144, and a pair of rails 148 which extend longitudinally parallel with longitudinal axis 141 of top hat assembly 140 and which are positioned proximal the outer side 147 of outer top hat 142. As will be described further herein, each rail 148 of outer top hat 142 comprises an outer contact surface 150 oriented in the direction of outer side 147 and is configured to contact and press against one of the solar modules 50 of solar array 10. While in FIGS. 4-7 outer top hat 142 is shown as comprising a single member, in other embodiments, outer top hat 142 may comprise a plurality of separate members. In some embodiments, contact surfaces 150 may comprise surface features (e.g., teeth, ridges, buttons, etc.) which enhance a surface roughness of the contact surface 150 and allow the contact surfaces 150 to bite into and through an exterior coating of the solar modules 50 to electrically connect the outer top hat 142 with the solar modules 50.

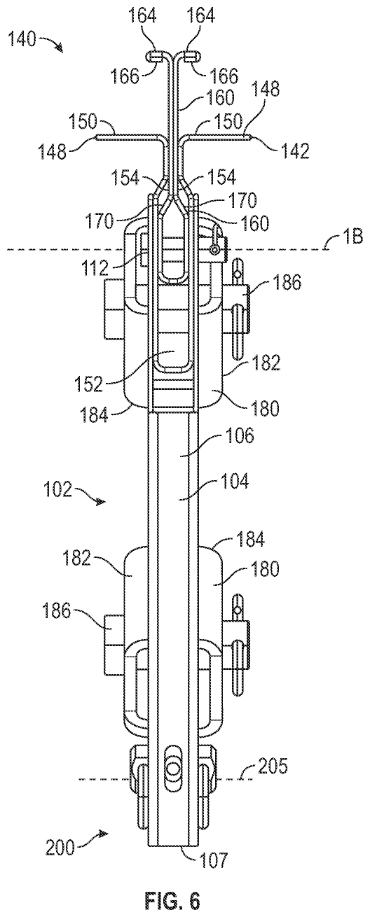

Additionally, in this exemplary embodiment, outer top hat 142 comprises a longitudinally extending receptacle 152 positioned along the inner side 149 of top hat assembly 140. Receptacle 152 of outer top hat 142 receives a portion of the inner top hat 160 of top hat assembly 140 to thereby couple inner top hat 160 with outer top hat 142. As shown particularly in FIG. 6, receptacle 152 includes a pair of internal inclined surfaces 154 located at an outer end (e.g., an end proximal outer side 147) of receptacle 152.

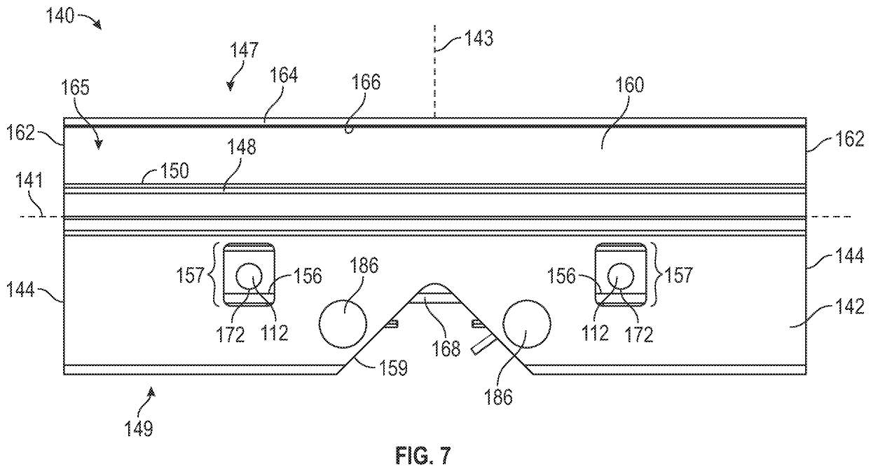

In this exemplary embodiment, the pivot joints 112 of actuator arm assembly 102 extend through the outer top hat 142 and receptacle 152 thereof. As shown particularly in FIG. 7 (the actuator arm assembly 102 and fastener assembly 200 are hidden in FIG. 7 for clarity), outer top hat 142 comprises a plurality of slotted openings 156 through which the pivot joints 112 of actuator arm assembly 102 extends. Slotted openings 156 are sized to permit a predetermined amount of relative travel along lateral axis 143 between the outer top hat 142 and the actuator arms 104 of actuator arm assembly 102. Particularly, each slotted opening 156 has a length 157 in the lateral direction which is greater than a diameter of each pivot joint 112. By permitting a predetermined amount of relative travel along lateral axis 143 between outer top hat 142 and actuator arms 104, the top hat assembly 140 of mounting bracket 100 may accept and couple with solar modules 50 of varying sizes and thicknesses provided by a variety of different original equipment manufacturers (OEMs). Additionally, in this exemplary embodiment, an inclined recess 159 is formed in the outer top hat 142 along an inner edge thereof located at the inner side 149 of top hat assembly 140. Recess 159 is aligned with the lateral axis 143 of top hat assembly 140 and is positioned between the pair of actuator arms 104 of actuator arm assembly 102.

In this exemplary embodiment, the inner top hat 160 has a pair of opposed longitudinal ends 162, and a pair of rails 164 which extend longitudinally parallel with longitudinal axis 141 of top hat assembly 140 and which are located at the outer side 147 of top hat assembly 140. As will be described further herein, each rail 164 of inner top hat 160 comprises an inner contact surface 166 oriented in the direction of inner side 149 and configured to contact and press against one of the solar modules 50 of solar array 10. Similar to the contact surfaces 150 of outer top hat 142, in some embodiments, contact surfaces 166 of inner top hat 160 may comprise surface features (e.g., teeth, ridges, buttons, etc.) which enhance a surface roughness of the contact surface 166 and allow the contact surfaces 166 to bite into and through the exterior coating of the solar modules 50 to electrically connect the inner top hat 150 with the solar modules 50). While inner top hat 160 is shown as comprising a single, integrally formed member in FIGS. 4-7, in other embodiments, inner top hat 160 may comprise a plurality of separate and distinct members (e.g., rails 164 may comprise portions of the separate members comprising inner top hat 160).

Additionally, a pair of receptacles 165 is formed between the pair of rails 164 of inner top hat 160 and the pair of rails 148 of outer top hat 142. As will be described further herein, a pair of solar modules 50 of solar array 10 may be inserted into the pair of receptacles 165 of top hat assembly 140 where the pair of solar modules 50 may be gripped by the contact surfaces 150, 166 of rails 148, 164, respectively, following the assembly of the solar modules 50 with mounting bracket 100.

Inner top hat 160 additionally includes a longitudinally extending retainer 168 located along an inner side (e.g., the side of inner top hat 160 proximal the inner side 149 of top hat assembly 140) of inner top hat 160 and slidably positioned in the receptacle 152 of outer top hat 142. The retainer 168 includes a pair of external inclined surfaces 170 located at an outer end (e.g., an end proximal outer side 147) of retainer 168 and which are in interference with the internal inclined surfaces 154 of the receptacle 152 of outer top hat 142. In this configuration, while the portion of inner top hat 160 extending from retainer 168 towards rails 164 extends through a gap formed between the rails 148 of outer top hat 142, contact between the external inclined surfaces 170 of retainer 168 and the internal inclined surfaces 154 of the receptacle 152 of outer top hat 142 trap the retainer 168 within receptacle 152. However, the receptacle 152 has a length along the lateral axis 143 which is greater than a length of the retainer 168, thereby permitting a predefined amount of relative travel along lateral axis 143 between outer top hat 142 and inner top hat 160.

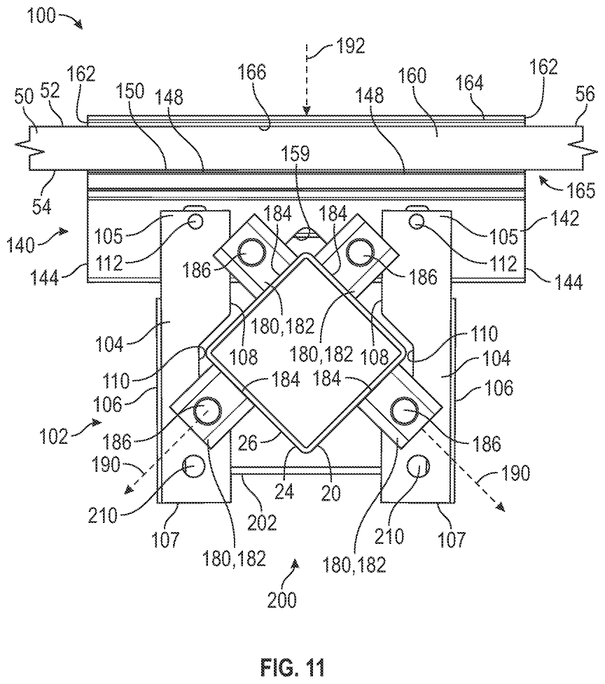

In this exemplary embodiment, the pivot joints 112 of actuator arm assembly 102 also extend through the inner top hat 160, thereby coupling actuator arm assembly 102 with inner top hat 160. Particularly, pivot joints 112 extend through apertures 172 formed in the retainer 168 of inner top hat 160. Unlike the slotted openings 156 of outer top hat 142, apertures 172 of inner top hat 160 are sized so as to restrict relative movement between inner top hat 160 and the actuator arms 104 of actuator arm assembly 102 along lateral axis 143. Thus, travel of the actuator arms 104 along lateral axis 143 relative to outer top hat 142 results in corresponding travel of the inner top hat 160 along lateral axis 143 relative to outer top hat 142. As will be discussed further herein, in this exemplary embodiment, inner top hat 160 and actuator arms 104 may travel along lateral axis 143 between a first or extended position (shown in FIGS. 4-7) and a second or retracted position (shown in FIG. 11) that is spaced from the extended position along axis 143.

As will be described further herein, a distance or height of each receptacle 165 of top hat assembly 140 along lateral axis 143 is altered as inner top hat 160 and actuator arms 104 travel between the extended and retracted positions. Particularly, each receptacle 165 comprises a first height along lateral axis 143 when inner top hat 160/actuator arms 104 are in the extended position and a second height along lateral axis 143 when inner top hat 160/actuator arms 104 are in the retracted position, where the second height is less than the first height. The extended first height of receptacles 165 allows for the convenient insertion of a pair of solar modules 50 into receptacles 165 while the retracted second height of receptacles 165 allows contact surfaces 150, 166 of rails 148, 164, respectively, to grip and lock against the pair of solar modules 50 received therein.

While the top hat assembly 140 of mounting bracket 100 is configured to contact and grip one or more solar modules 50 of solar array 10, mounts 180 of mounting bracket 100 are configured to contact and grip one of the torque tubes 24 of support structure 20 to thereby couple mounting bracket 100 with support structure 20. In this exemplary embodiment, each mount 180 comprises a generally U-shaped body 182 including a contact surface 184 at a longitudinal end thereof. The contact surface 184 of each mount 180 is configured to contact one of the planar faces of the outer surface 26 of a torque tube 24. Additionally, each mount 180 comprises a coupling pin 186 which couples the mount 180 to either one of the actuator arms 104 of actuator arm assembly 102 or to the outer top hat 142 of top hat assembly 140. Particularly, a lower pair of mounts 180 are at least partially received in the recesses 110 formed in actuator arms 104 and are coupled thereto. Additionally, an upper pair of mounts 180 are at least partially received in the recess 159 of outer top hat 142 and are coupled thereto.

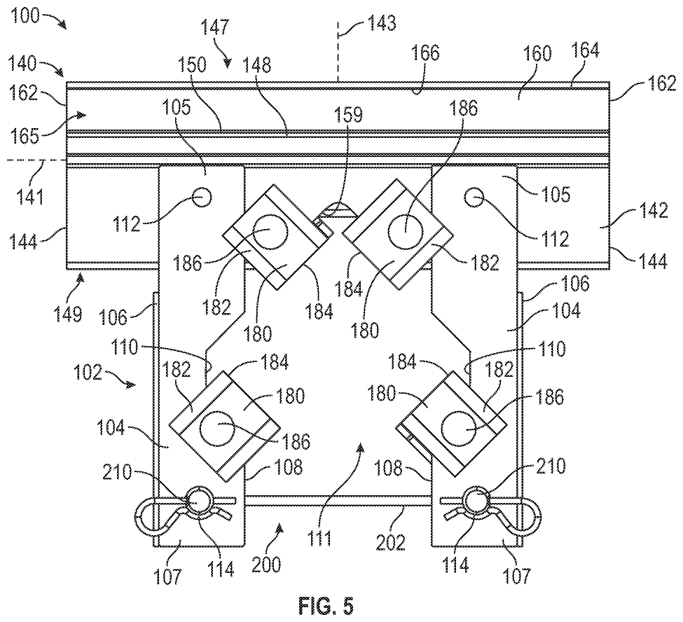

In this exemplary embodiment, when actuator arms 104 are in the enclosed position shown in FIG. 5, each mount 180 is inclined relative to both the longitudinal axis 141 and lateral axis 143 of top hat assembly 140. Additionally, each mount 180 is oriented in the direction of opening 111 formed between the pair of actuator arms 104 when in the enclosed position. In some embodiments, the pins 186 of mounts 180 are configured to provide at least a limited degree of relative movement between mounts 180 and the actuator arms 104 and outer top hat 142 to which they are coupled. For example, the pins 186 of the lower pair of mounts 180 may permit mounts 180 to pivot relative actuator arms 104 about rotational axes which extend longitudinally through the pins 186 thereof while the pins 186 of the upper pair of mounts 180 may permit mounts 180 to pivot similarly relative to outer top hat 142. This limited freedom of movement of mounts 180 may allow contact surfaces 184 of mounts 180 to sit flat against the planar faces of the outer surface 26 of the torque tube 24 to which the mounting bracket 100 is coupled.

The fastener assembly 200 of mounting bracket 100 does not directly contact either the solar modules 50 or support structure 20 of solar array 10 and instead secures or locks the actuator arms 104 of actuator arm assembly 102 into the enclosed position thereby concurrently locking the mounting bracket 100 to both one or more solar modules 50 and to the support structure 20. In this exemplary embodiment, fastener assembly 200 comprises a cylindrical connector rod 202 and a pair of cylindrical retention or barrel nuts 210. Each barrel nut 210 is received within a corresponding opening 114 formed in the actuator arms 104 of actuator arm assembly 102 proximal the second ends 107 thereof.

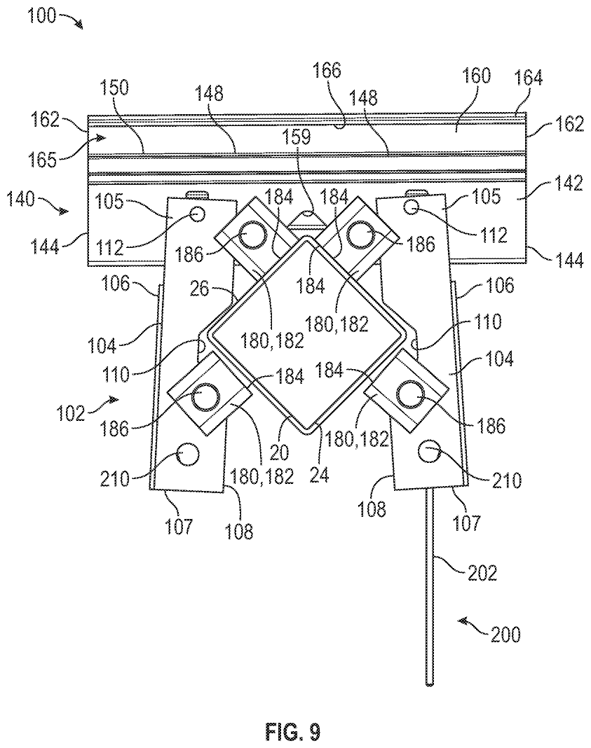

In this exemplary embodiment, connector rod 202 is externally threaded and receivable within an aperture formed in each barrel nut 210. Additionally, the aperture of one of the barrel nuts 210 is internally threaded to threadably couple connector rod 202 with the barrel nut 210. Particularly, fastener assembly 200 includes a locked configuration (shown in FIGS. 4-7) in which connector rod 202 is threadably connected to each of the barrel nuts 210 of fastener assembly 200, and an unlocked configuration (shown in FIGS. 8, 9) in which connector rod 202 is only threadably coupled to one of the barrel nuts 210. In the unlocked configuration, while connector rod 202 extends from one of the actuator arms 104 access may be provided to the opening 111 formed between the pair of actuator arms 104. For example, when in the unlocked configuration, a torque tube 24 of the support structure 20 may be inserted into the opening 111. However, in the locked configuration, connector rod 202 encloses the opening 111 such that torque tube 24 may not be inserted into opening 111 by displacing the torque tube 24 relative to the mounting bracket 100 in a lateral direction (e.g., a direction parallel with lateral axis 143).

In the unlocked configuration, the connector rod 202 may pivot about a rotational axis 205 which extends longitudinally through the barrel nut 210 to which the connector rod 202 is coupled when in the unlocked configuration. In this exemplary embodiment, the rotational axis 205 extends parallel with the rotational axes 113 of actuator arm assembly 102. Additionally, while in this exemplary embodiment fastener assembly 200 includes connector rod 202 and a pair of barrel nuts 210, in other embodiments, fastener assembly 200 may only include a single connector and a single barrel nut 210. For example, connector rod 202 may be coupled directly to one of the actuator arms 104 instead of indirectly through one of the barrel nuts 210 when the fastener assembly 200 is in the unlocked configuration. In still other embodiments, fastener assembly 200 may include a mechanism other than barrel nuts 210 and connector rod 202. For example, in another embodiment, barrel nuts 210 may comprise eye-bolts and connector rod 202 may comprise a turnbuckle threadably connectable to the eye-bolts. In another embodiment, the barrel nut 210 comprising the threaded aperture may comprise a threaded nut positioned external the actuator arm 104 and which presses against the actuator arm 104 with a spherical bolt.

Referring now to FIGS. 8-11, an exemplary process for coupling one or more solar modules 50 to the support structure 20 of solar array 10 is shown. In some embodiments, the support structure 20 of solar array 10 may be assembled prior to the coupling of the solar modules 50 to the support structure 20 via mounting brackets 100. For example, torque tubes 24 may first be connected end-to-end and coupled with drive motor 35 (supported by support beams 22) prior to coupling solar modules 50 with support structure 20. Alternatively, one or more solar modules 50 may first be coupled to a given torque tube 24 via mounting brackets 100 before the torque tube 24 is assembled with the other components of support structure 20. To state in other words, solar modules 50 may be assembled with torque tubes 24 concurrently with the assembly of support structure 20.

As shown particularly in FIGS. 8, 9, initially the mounting bracket 100 may be positioned at a desired location along one of the torque tubes 24 of support structure 20. For example, the mounting bracket 100 may be manually (e.g., via personnel tasked with installing solar array 10 at a chosen location) lowered vertically over the torque tube until the upper pair of mounts 180 contact an upper pair of planar faces of the outer surface 26 of torque tube 20. The actuator arms 104 of mounting bracket 100 may be pivoted outwardly away from the torque tube 24 as the mounting bracket 100 is lowered over the torque tube 24 to allow the torque tube 24 to fit between the pair of actuator arms 104 during the lowering of mounting bracket 100. Once the upper pair of mounts 180 are positioned proximal, or contact, the outer surface 26 of the torque tube 24, the actuator arms 104 may be allowed to swing inwardly such that the lower pair of mounts 180 are also located proximal the outer surface 26 of torque tube 24, as shown particularly in FIG. 9. Additionally, during this lowering process, the fastener assembly 200 is in the unlocked configuration with the connector rod 202 thereof hanging vertically from a first barrel nut 210 (shown on the right-hand side of FIGS. 8-11) to thereby permit the torque tube 24 to enter into the space extending between the pair of actuator arms 104.

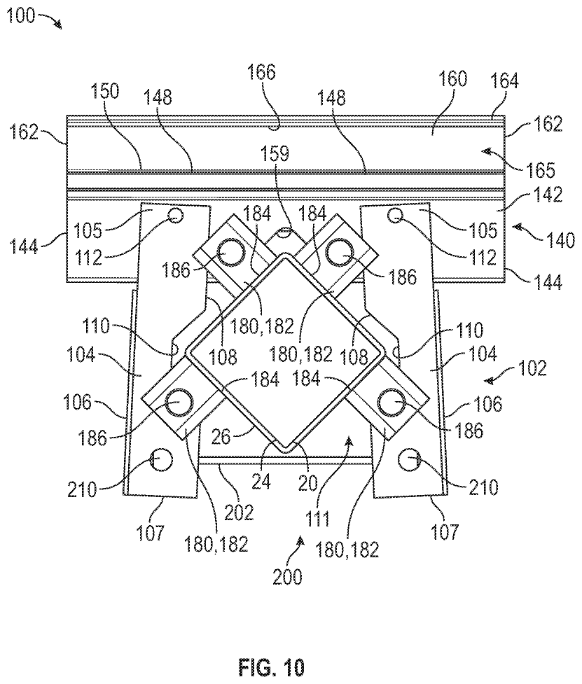

Once mounting bracket 100 is landed upon torque tube 24 as shown, for example, in FIG. 9, fastener assembly 200 may be actuated to provisionally couple the mounting bracket 100 to the torque tube 24. Particularly, the connector rod 202 may be rotated into alignment with a second barrel nut 210 (the connector rod 202 being connected to the first barrel nut 210 and shown on the left-hand side of FIGS. 8-11)) and inserted into the threaded aperture of the second barrel nut 210, as shown particularly in FIG. 10. The externally threaded connector rod 202 may be manually threaded into the threaded aperture of the second barrel nut 210 to couple the connector rod 202 with the second barrel nut 210. However, the connector rod 202 may not be tightened against the second barrel nut 210, such that actuator arms 104 and the inner top hat 160 are disposed in the extended position.

With mounting bracket 100 in the position shown in FIG. 10, one or more solar modules 50 may be inserted into the receptacles 165 of top hat assembly 140, where receptacles 165 each extend along the extended first height corresponding to the extended position of inner top hat 160/actuator arms 104. Particularly, a portion of the outer frame 56 extending along a lateral edge of the solar module 50 is inserted into the receptacle 165 such that the outer frame 56 abuts or is positioned adjacent the inner top hat 160 of top hat assembly 140. In this configuration, the lower surface 54 of the solar module 50 is supported on the contact surface 150 of the rail 148 of outer top hat 142.

Once the solar module 50 (or both solar modules 50 in the instance where mounting bracket 100 is coupled to a pair of solar modules 50) is inserted into one of the receptacles 165 of top hat assembly 140, inner top hat 160 and actuator arms 104 may be actuated from the extended position to the retracted position for both and concurrently lock the solar module 50 (or pair of solar modules 50) to the mounting bracket 100 and to lock the mounting bracket 100 to the torque tube 24 such that relative movement is restricted between both the solar module 50 and the mounting bracket 100, and between the mounting bracket 100 and the torque tube 24 to which the mounting bracket 100 is coupled.

Particularly, in this exemplary embodiment, connector rod 202 is manually rotated (e.g., via by hand or a hand tool which engages the connector rod 202) to further insert the connector rod 202 through the aperture of the second barrel nut 210 of fastener assembly 200. As the connector rod 202 is threaded into the second barrel nut 210, inclined engagement between the lower pair of mounts 180 coupled to actuator arms 104 and the outer surface 26 of torque tube 24 translates the force applied to connector rod 202 into a compressive force against inner top hat 160 and the pair of actuator arms 104. The compressive force applied against the inner top hat 160 is parallel with the lateral axis 143.

Specifically, contact between the lower pair of mounts 180 and the inclined planar faces of the outer surface 26 of torque tube 24 produces reaction forces (indicated by arrows 190 in FIG. 11) which extend at a non-zero angle relative to the lateral axis 143 and in a direction extending away from the solar module 50. Reaction forces 190 are transferred through actuator arms 104 and to the inner top hat 160 has a compressive force (indicated by arrow 192 in FIG. 11) parallel with lateral axis 143 and extending towards the solar module 50. In this exemplary embodiment, when mounting bracket 100 is landed against torque tube 24 as shown in FIGS. 8-11, each inclined planar face or surface defining the outer surface 26 of torque tube 24 is disposed at a non-zero, non-orthogonal angle relative to both the longitudinal and lateral axes 141, 143 of top hat assembly 140. The planar faces 26 of torque tube 24 are similarly disposed at non-zero, non-orthogonal angles relative to longitudinal and lateral axes of the solar module 50 (or pair of solar modules 50) coupled to the mounting bracket 100.

In this manner, the compressive force 192 applied to inner top hat 160 which forces inner top hat 160 to travel downwardly along lateral axis 143 towards solar module 50 until the contact surface 166 of a corresponding rail 164 of inner top hat 160 is compressed against the upper surface 52 of the solar module 50 with the inner top hat 160 in the retracted position. The lower pair of mounts 180 coupled to actuator arms 104 slide downwards along the outer surface 26 of torque tube 24 as inner top hat 160 travels downwardly towards the solar module 50 along lateral axis 143.

Additionally, contact between the upper pair of mounts 180 coupled to outer top hat 142 and the outer surface 26 of torque tube 24 prevents lower top hat 142 from moving along lateral axis 143 relative to solar module 50. Thus, compression of the contact surface 166 of inner top hat 160 against the upper surface 52 of solar module 50 results in corresponding compression of one of the contact surfaces 150 of outer top hat 142 against the lower surface 54 of solar module 50. Torque may be applied to connector rod 202 of fastener assembly 200 until a desired degree of contact or contact pressure is established between the contact surfaces 150, 166 of top hats 142, 160, respectively, and solar module 50. At the same time, a desired degree of contact or contact pressure may also be established between mounts 180 and the torque tube 24. Additionally, as described above, contact surfaces 150, 166 may include surface features configured to increase a roughness of surfaces 150, 166 so that an electrical connection between the solar module 50 and the mounting bracket 100 is established, thereby grounding the solar module 50 to the support structure 20 through the mounting bracket 100. For example, in some embodiments, holes may be cut or punched into contact surfaces 150, 166 to form sharp edges thereon which may pierce into the surfaces 52, 50 of solar module 50 which may not have sufficient electrical conductivity for grounding the solar module 50.

As described above, by threadably connecting the connector rod 202 with only the second barrel nut 210, mounting bracket 100 may be locked to both the solar module 50 (or a pair of solar modules 50) and the torque tube 24 while also forming an electrical connection between the solar module (or pair of solar modules 50) and the support structure 20, grounding the solar module 50 to the support structure 20. Thus, only a single mechanical connection (between connector rod 202 and the second barrel nut 210) need be made to lock the mounting bracket 100 to both support structure 20 and one or more solar modules 50, minimizing the time required for installing the mounting bracket 100 relative to brackets which require more than one mechanical connection to be made during installation. The reduced time required for installing each mounting bracket 100 may result in a substantial reduction in the time required to assemble solar array 10 comprising thousands of manually installed mounting brackets 100, in-turn reducing the costs associated with installing solar array 10.

Additionally, mounting bracket 100 may couple with solar modules 50 of various sizes in terms of widths, lengths, and thicknesses. Mounting bracket 100 may also accommodate torque tubes 24 of various sizes. In this manner, mounting brackets 100 may be utilized in a variety of applications to mount solar modules 50 of varying sizes to torque tubes 24 of varying sizes.

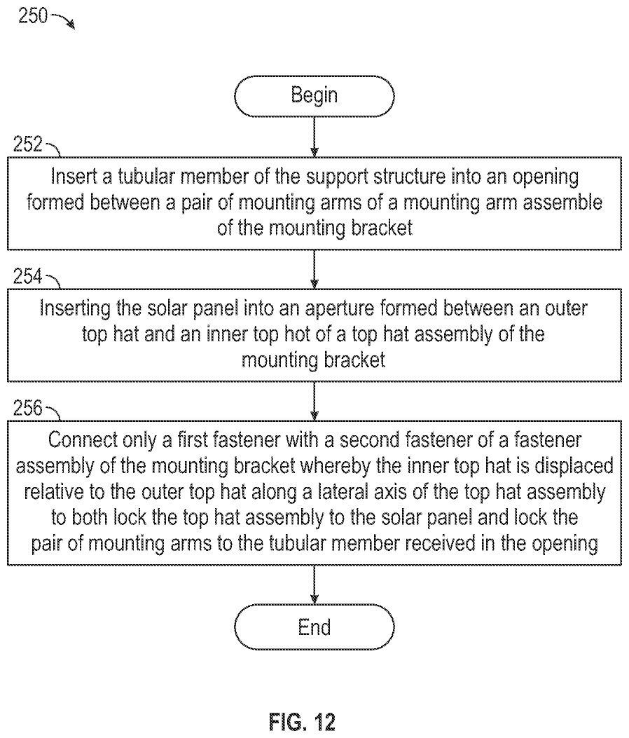

Referring now to FIG. 12, an embodiment of a method 250 for coupling a solar module of a solar array to a support structure of the solar array is shown. Initially, block 252 of method 250 includes inserting a tubular member of the support structure into an opening formed between a pair of actuator arms of an actuator arm assembly of the mounting bracket. In some embodiments, block 252 includes inserting a torque tube 24 of the solar array 10 shown in FIGS. 1-3 into the opening 111 of the mounting bracket 100 shown in FIGS. 4-11. At block 254, method 250 includes inserting the solar module into a receptacle or aperture formed between an outer top hat and an inner top hot of a top hat assembly of the mounting bracket. In some embodiments, block 254 includes inserting one of the solar modules 50 of solar array 10 into one of the apertures 165 of the top hat assembly 140 of mounting bracket 100.

At block 256, method 250 includes mechanically connecting only a first fastener with a second fastener of a fastener assembly of the mounting bracket whereby the inner top hat is displaced relative to the outer top hat along a lateral axis of the top hat assembly to both lock the top hat assembly to the solar module and lock the pair of actuator arms to the tubular member received in the opening. In some embodiments, block 256 includes mechanically connecting only the connector rod 202 with one of the barrel nuts 210 of fastener assembly 200 of mounting bracket 100 whereby the inner top hat 160 of mounting bracket 100 is displaced relative to outer top hat 142 along the lateral axis 143 to both lock the top hat assembly 140 to the solar module 50 and lock the pair of actuator arms 104 to the torque tube 24 received in opening 111.

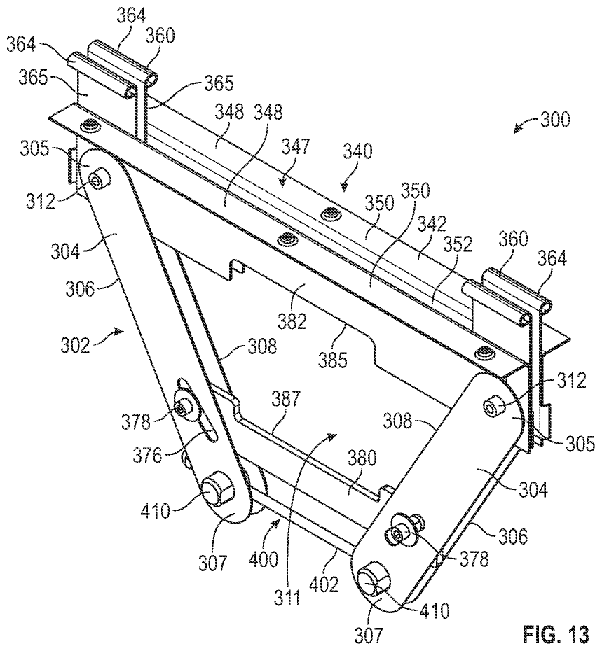

Referring now to FIGS. 13-16, views of a second embodiment of the mounting brackets 100 of solar array 10 are shown, including a mounting bracket 300. It is noted that mounting bracket 300 shares certain features with mounting bracket 100. For purposes of avoiding redundancy and providing clarity, such similar features are not repeated in the following discussion and instead are incorporated from the discussion above.

In this exemplary embodiment, mounting bracket 300 generally includes an actuator arm assembly 302, a top hat assembly 340, a plurality of mounts 380, 382, and a fastener assembly 400. As will be discussed further herein, actuator arm assembly 302 in conjunction with mounts 380, 382 and fastener assembly 400 secures mounting bracket 300 to one of the torque tubes 24 of support structure 20 while the top hat assembly 340 secures the mounting bracket 300 to one or more solar modules 50. As described above with respect to mounting bracket 100, the components of mounting bracket 300 can similarly be formed from an electrically conductive material.

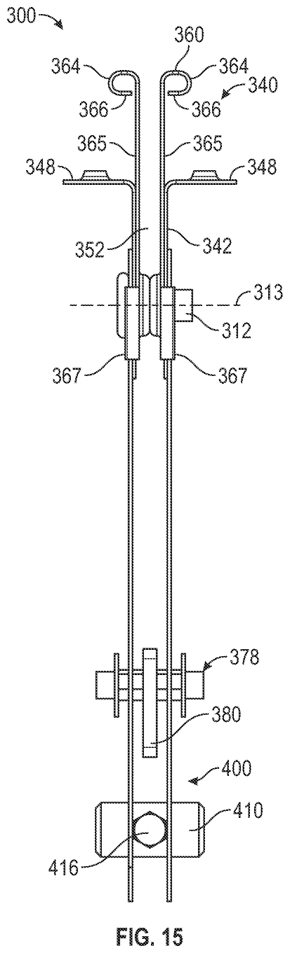

In this exemplary embodiment, actuator arm assembly 302 comprises a pair of opposed actuator arms 304 each extending between a longitudinal first end 305 and a longitudinal second end 307 opposite the first end 305. Additionally, each actuator arm 304 has an outer lateral side 306 and an inner lateral side 308 opposite the outer lateral side 306. Each actuator arm 304 is pivotably coupled to the top hat assembly 340 of mounting bracket 300 by a pivot joint or pin 312 which extends through the first end 305 of the respective actuator arm 304 via an aperture 310. In this configuration, each actuator arm 304 may pivot about a rotational axis 313 (FIG. 15). Extending from top hat assembly 340, actuator arms 304 form an opening 311 along with lower mount 380 that is configured to securely receive a torque tube 24 of the support structure 20 of solar array 10.

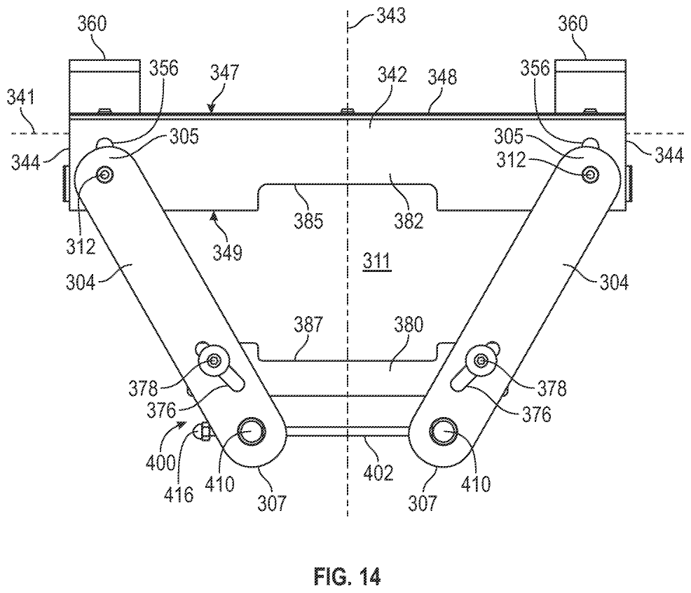

The top hat assembly 340 of mounting bracket 300 is configured to contact and grip one or more solar modules 50 to thereby secure the one or more solar modules 50 to the mounting bracket 300. In this exemplary embodiment, top hat assembly 340 generally includes an outer top hat 342 and a plurality of inner, spaced-apart top hats 360 that are slidably positioned in the outer top hat 342. Additionally, top hat assembly 340 includes a longitudinal axis 341 (not necessarily a central axis of top hat assembly 340) and a lateral axis 343 which extends orthogonally to longitudinal axis 341 (FIG. 14). Further, top hat assembly 340 has a first or outer side 347 distal actuator arm assembly 302 and a second or inner side 349, opposite outer side 347 along lateral axis 343, proximal actuator arm assembly 302 (FIG. 14).

In this exemplary embodiment, the outer top hat 342 has a pair of opposed longitudinal ends 344, and a pair of rails 348 which extend longitudinally parallel with longitudinal axis 341 of top hat assembly 340 and which are positioned proximal the outer side 347 of outer top hat 342. As will be described further herein, each rail 348 of outer top hat 342 comprises an outer contact surface 350 oriented in the direction of outer side 347 and is configured to contact and press against one of the solar modules 50 of solar array 10. In some embodiments, outer top hat 342 may comprise a plurality of separate members.

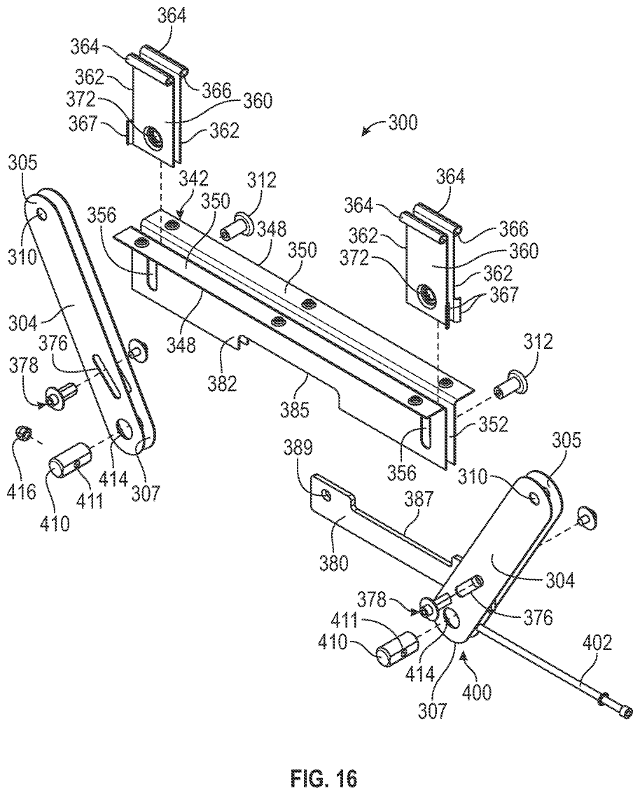

Additionally, in this exemplary embodiment, outer top hat 342 comprises a longitudinally extending receptacle 352 (FIGS. 15, 16). Receptacle 352 of outer top hat 342 receives a portion of inner top hats 360 of top hat assembly 340 to thereby couple inner top hats 360 with outer top hat 342. As shown particularly in FIG. 6, receptacle 152 includes a pair of internal inclined surfaces 154 located at an outer end (e.g., an end proximal outer side 147) of receptacle 152.

In this exemplary embodiment, the pivot joints 312 of actuator arm assembly 302 extend through the outer top hat 342 and receptacle 352 thereof. As shown particularly in FIGS. 14 and 16, outer top hat 342 includes a plurality of slotted openings 356 through which the pivot joints 312 of actuator arm assembly 102 extend. Pivot joints 312 may include any known rotatable or pivotable retention member or pin. Slotted openings 356 are sized to permit a predetermined amount of relative travel along lateral axis 343 between the outer top hat 342 and the actuator arms 304 of actuator arm assembly 302. Particularly, each slotted opening 356 has a length in the lateral direction which is greater than a diameter of each pivot joint 312. By permitting a predetermined amount of relative travel along lateral axis 343 between outer top hat 342 and actuator arms 304, the top hat assembly 340 of mounting bracket 300 may accept and couple with solar modules 50 of varying sizes and thicknesses provided by a variety of different original equipment manufacturers (OEMs). Additionally, in this exemplary embodiment, the upper mount 382 is a lower or bottom portion of the outer top hat 342 and includes a recess or cutout 385. The recess or cutout 385 is configured to receive and capture a torque tube 24 of support structure 20.

In this exemplary embodiment, and with particular reference to FIGS. 15 and 16, the inner top hats 360 have pairs of opposed longitudinal ends 362, and pairs of rails 364 which extend longitudinally parallel with longitudinal axis 341 of top hat assembly 340. The ends 362 further include angled or curved retention tabs 367. As will be described further herein, each rail 364 of inner top hats 360 includes an inner contact surface 366 oriented in the direction of outer top hat rails 348 and configured to contact and press against one of the solar modules 50 of solar array 10. Similar to the contact surfaces 350 of outer top hat 342, in some embodiments, contact surfaces 366 of inner top hats 360 may comprise surface features as described previously.

Additionally, a pair of receptacles 365 is formed between the pair of rails 364 of each inner top hat 360 and the pair of rails 348 of outer top hat 342. As will be described further herein, a pair of solar modules 50 of solar array 10 may be inserted into the pair of receptacles 365 of top hat assembly 340 where the pair of solar modules 50 may be gripped by the contact surfaces 350, 366 of rails 348, 364, respectively, following the assembly of the solar modules 50 with mounting bracket 300.

In this exemplary embodiment, the pivot joints 312 of actuator arm assembly 302 also extend through the inner top hats 360, thereby coupling actuator arm assembly 302 with inner top hat 360. Particularly, pivot joints 312 extend through apertures 372 formed in the inner top hats 360. Unlike the slotted openings 356 of outer top hat 342, apertures 372 of inner top hats 360 are sized so as to restrict relative movement between inner top hats 360 and the actuator arms 304 of actuator arm assembly 302 along lateral axis 343. Thus, travel of the actuator arms 304 along lateral axis 343 relative to outer top hat 342 results in corresponding travel of the inner top hats 360 along lateral axis 343 relative to outer top hat 342. As will be discussed further herein, in this exemplary embodiment, inner top hats 360 and actuator arms 304 may travel along lateral axis 343 between a retracted position (shown in FIG. 14) and an extended position wherein the pivot joints 312 travel to an upper extent of the slotted openings 356, and the inner top hats 360 and the actuator arm assembly together move a corresponding distance along lateral axis 343.

As will be described further herein, a distance or height of each receptacle 365 of top hat assembly 340 along lateral axis 343 is altered as inner top hats 360 and actuator arms 304 travel between the extended and retracted positions. Particularly, each receptacle 365 has a first height along lateral axis 343 when inner top hats 360/actuator arms 304 are in the extended position and a second height along lateral axis 343 when inner top hats 360/actuator arms 304 are in the retracted position, where the second height is less than the first height. The extended first height of receptacles 365 allows for the convenient insertion of a pair of solar modules 50 into receptacles 365 while the retracted second height of receptacles 365 allows contact surfaces 350, 366 of rails 348, 364, respectively, to grip and lock against the pair of solar modules 50 received therein.

While the top hat assembly 340 of mounting bracket 300 is configured to contact and grip one or more solar modules 50 of solar array 10, mounts 380, 382 of mounting bracket 300 are configured to contact and capture one of the torque tubes 24 of support structure 20 to thereby couple mounting bracket 300 with support structure 20. In this exemplary embodiment, upper mount 382 is the lower portion of the outer top hat 342 and includes the recess or cutout 385, as previously described. The recess 385 may also be referred to as a contact surface. The lower mount 380 is an elongate member having a recess or cutout 387 that is a contact surface. The contact surfaces of each mount are configured to contact one of the planar faces of the outer surface 26 of a torque tube 24. The lower mount 380 further includes apertures 389 for receiving sliding retention or pin assemblies 378. The sliding pin assemblies 378 extend through angled slot openings or apertures 376 in the actuator arms 304.

The fastener assembly 400 of mounting bracket 300 does not directly contact either the solar modules 50 or support structure 20 of solar array 10 and instead moves and adjusts, and secures or locks the actuator arms 304 of actuator arm assembly 302 into the proper position that concurrently locks the mounting bracket 300 to both one or more solar modules 50 and to the support structure 20. In this exemplary embodiment, fastener assembly 400 includes a connector rod or thread bolt 402 and a pair of cylindrical retention or barrel nuts 410. Each barrel nut 410 includes an aperture 411, and is received within a corresponding opening or aperture 414 (FIG. 16) formed in the actuator arms 304 of actuator arm assembly 302 proximal the second ends 307 thereof. The connector rod 402 also includes an end nut 416.

In this exemplary embodiment, connector rod 402 is externally threaded and receivable within aperture 411 formed in each barrel nut 410. Additionally, the aperture 411 of at least one of the barrel nuts 410 is internally threaded to threadably couple the connector rod 402 with the threaded barrel nut 410. Fastener assembly 400 includes an open or unlocked configuration in which connector rod 402 is loosened and lower mount 380 is allowed to move downward by sliding pin assemblies 378 sliding in angled slot openings 376. Concurrently, the inner tops hats 360 are in the extended position wherein the pivot joints 312 travel to an upper extent of the slotted openings 356, as previously described. During any such movements of the pivot joints 312, inner top hats 360, and lower mount 380, the actuator arms 304 may pivot about any or all of the pivot joints 312, the sliding pin assemblies 378, and the barrel nuts 410. In the open or unlocked configuration, the mounting bracket 300 can be slid onto a torque tube 24 or a torque tube 24 can be inserted into the opening 311.

Fastener assembly 400 also includes a closed or locked configuration wherein the connector rod 402 is rotated via the end nut 416 and the threaded interaction between the connector rod 402 and the threaded barrel nut causes the ends 307 of the actuator arms 304 to pivot at barrel nuts 410 and move closer together. This movement causes the sliding pin assemblies 378 to move or slide in angled slot openings 376, which in turn causes the lower mount 380 to move upward, thereby tightening the opening 311 and tightening the mounting bracket 300 about a torque tube 24. The torque tube 24 is then captured between the upper mount 382 and the lower mount 380. Concurrently, the inner top hats 360 and actuator arms 304 may travel along lateral axis 343 such that the pivot joints 312 travel down in the slotted openings 356 to a retracted position, as previously described. Such movement to the retracted positions of the inner top hats 360 causes the mounting bracket 300 to clamp down on the solar module 50.

The tightening or clamping force provided by the movement or rotation of the connector rod 402 as just described is caused by the angles of the angled slot openings 376. In some embodiments, the angles of these angled slot openings 376 can be designed or adjusted based on clamping forces desired or differing models of torque tubes 24, support structures 20, and/or solar arrays 10.

In some embodiments, one or more solar modules 50 may first be coupled to a given torque tube 24 via mounting brackets 300 before the torque tube 24 is assembled with the other components of support structure 20. To state in other words, solar modules 50 may be assembled with torque tubes 24 concurrently with the assembly of support structure 20. In this manner, the torque tubes 24 may be received within the openings 311 of the mounting brackets 300 while the mounting brackets 300 are in the open or unlocked configurations as previously described.

Once mounting bracket 300 is landed upon torque tube 24, fastener assembly 400 may be actuated to provisionally couple the mounting bracket 300 to the torque tube 24. Particularly, the connector rod 402 may be manually rotated while in threaded engagement with the threaded barrel nut 410 to begin the process of drawing the actuator arm ends 307 closer together while also pivoting the actuator arms 304 about the barrel nuts 410 and the pivot joints 312. Concurrently, the sliding pin assemblies 378 move in angled slot openings 376, as previously described, to also move the lower mount 380 toward the upper mount 382, and the pivot joints 312 travel down in the slotted openings 356 toward a retracted position, as previously described.

With mounting bracket 300 in an intermediate position between fully open or unlocked and fully close or locked, one or more solar modules 50 may be inserted into the receptacles 365 of top hat assembly 340, where receptacles 365 each extend along the extended first height corresponding to the extended position of inner top hats 360 and actuator arms 304. Particularly, a portion of the outer frame 56 extending along a lateral edge of the solar module 50 is inserted into the receptacle 365 such that the outer frame 56 abuts or is positioned adjacent the inner top hats 360 of top hat assembly 340. In this configuration, the lower surface 54 of the solar module 50 is supported on the contact surface 350 of the rail 348 of outer top hat 342.

Once the solar module 50 (or both solar modules 50 in the instance where mounting bracket 300 is coupled to a pair of solar modules 50) is inserted into one of the receptacles 365 of top hat assembly 340, inner top hats 360 and actuator arms 304 may be actuated from the extended or intermediate position to the retracted position for both and concurrently lock the solar module 50 (or pair of solar modules 50) to the mounting bracket 300 and to lock the mounting bracket 300 to the torque tube 24 such that relative movement is restricted between both the solar module 50 and the mounting bracket 300, and between the mounting bracket 300 and the torque tube 24 to which the mounting bracket 300 is coupled.

Particularly, in this exemplary embodiment, connector rod 402 is manually rotated (e.g., via by hand or a hand tool which engages the connector rod 402 or end nut 416) to further insert the connector rod 402 through the apertures 411 of the barrel nuts 410 of fastener assembly 400. As the connector rod 402 is threaded into the threaded barrel nut 410, angled or inclined engagement between the sliding pin assemblies 378 and angled slot openings 376 in the actuators arms 304 translates the force applied to connector rod 402 into compressive forces against the pair of actuator arms 304, the lower mount 380, and the inner top hats 360. In this manner, the mechanical rotational or torqueing force applied to only the connector rod 402 causes the actuator arms 304 to move, thereby causing the lower mount 380 to move to capture a torque tube 24 and the inner top hats 360 to move to capture a solar module 50, as previously described.

Torque may be applied to connector rod 402 until a desired degree of contact or contact pressure is established between the contact surfaces 350, 366 of top hats 342, 360, respectively, and solar module 50. At the same time, a desired degree of contact or contact pressure may also be established between mounts 380, 382 and the torque tube 24.

As described above, by connecting the connector rod 402 with only the barrel nuts 410, including a threaded connection with the threaded barrel nut, mounting bracket 300 may be locked to both the solar module 50 (or a pair of solar modules 50) and the torque tube 24 while also forming an electrical connection between the solar module (or pair of solar modules 50) and the support structure 20, grounding the solar module 50 to the support structure 20. Thus, only a single mechanical connection (between connector rod 402 and at least one of the barrel nuts 410) need be made to lock the mounting bracket 300 to both support structure 20 and one or more solar modules 50, minimizing the time required for installing the mounting bracket 300 relative to brackets which require more than one mechanical connection to be made during installation. The reduced time required for installing each mounting bracket 300 may result in a substantial reduction in the time required to assemble solar array 10 comprising thousands of manually installed mounting brackets 300, in turn reducing the costs associated with installing solar array 10.

Additionally, mounting bracket 300 may couple with solar modules 50 of various sizes in terms of widths, lengths, and thicknesses. Mounting bracket 300 may also accommodate torque tubes 24 of various sizes. In this manner, mounting brackets 300 may be utilized in a variety of applications to mount solar modules 50 of varying sizes to torque tubes 24 of varying sizes. As previously described, one feature that adds to the flexibility of the mounting bracket 300 in terms of size and force accommodations is the variability of the angle for angled slot openings 376.

Referring back to FIG. 12 and method 250, block 256 includes mechanically connecting only a first fastener with a second fastener of a fastener assembly of the mounting bracket whereby the inner top hat is displaced relative to the outer top hat along a lateral axis of the top hat assembly to both lock the top hat assembly to the solar module and lock the pair of actuator arms to the tubular member received in the opening. In some embodiments, block 256 includes mechanically connecting only the connector rod 402 with at least one of the barrel nuts 410 of fastener assembly 400 of mounting bracket 300 whereby the inner top hats 360 of mounting bracket 300 are displaced relative to outer top hat 342 along the lateral axis 343 to both lock the top hat assembly 340 to the solar module 50 and lock the pair of actuator arms 304 and mounts 380, 382 to the torque tube 24 received in opening 311.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the invention. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A mounting bracket for a solar array, the mounting bracket comprising:
a top hat assembly comprising a longitudinal axis, a lateral axis orthogonal the longitudinal axis, an outer top hat having a longitudinally extending first rail configured to contact a solar module of the solar array, and an inner top hat having a longitudinally extending second rail also configured to contact the solar module;
an actuator arm assembly comprising a pair of actuator arms which extend from the top hat assembly and which form an opening configured to receive a tubular member of the solar array; and
a fastener assembly configured to connect the pair of actuator arms and secure the mounting bracket to both the solar module and the tubular member, wherein the fastener assembly comprises a first fastener extending from a first actuator arm of the pair of actuator arms and a second fastener positioned in a second actuator arm of the pair of actuator arms, and wherein at least one of the first fastener and the second fastener is rotatable about a longitudinal axis of the first fastener when the first fastener is connected to the second fastener;
wherein the fastener assembly comprises an unlocked configuration permitting access to the opening, and a locked configuration which tightens the opening.

2. The mounting bracket of claim 1, wherein each of the pair of actuator arms are pivotally coupled to the top hat assembly.

3. The mounting bracket of claim 1, wherein relative movement along the lateral axis of the top hat assembly between the inner top hat and the pair of actuator arms is restricted.

4. The mounting bracket of claim 1, wherein a predefined degree of relative movement along the lateral axis of the top hat assembly between the outer top hat and the pair of actuator arms is permitted.

5. The mounting bracket of claim 1, wherein:
the first rail comprises a first contact surface configured to contact a first surface of the solar module, and the second rail comprises a second contact surface configured to contact an opposing second surface of the solar module; and
the first contact surface comprises a first edge formed thereon and configured to pierce the first surface of the solar module.

6. The mounting bracket of claim 5, wherein the first contact surface and the second contact surface are each electrically conductive.

7. The mounting bracket of claim 1, further comprising a plurality of mounts including a first pair of mounts coupled to the top hat assembly and a second pair of mounts coupled to the pair of actuator arms.

8. The mounting bracket of claim 7, wherein each of the plurality of mounts comprises a contact surface which extends at an acute or obtuse angle relative to the longitudinal axis of the top hat assembly.

9. The mounting bracket of claim 1, further comprising a lower mount including sliding pin assemblies, wherein the actuator arms include angled slot openings to receive the sliding pin assemblies, and wherein the fastener assembly comprises a connector rod coupled between ends of the actuator arms and the connector rod is rotatable to move the ends of the actuator arms and thereby cause the sliding pin assemblies to slide in the angled slot openings such that the lower mount moves relative to the actuator arms.

10. A solar array for producing electrical power from sunlight, the solar array comprising:
a solar module comprising one or more solar cells;
a support structure comprising a tubular member for supporting the solar module; and
a mounting bracket for locking the solar module to the tubular member of the support structure, the mounting bracket comprising:
a top hat assembly comprising a longitudinal axis, a lateral axis orthogonal the longitudinal axis, an outer top hat having a longitudinally extending first rail configured to contact a solar module of the solar array, and an inner top hat having a longitudinally extending second rail also configured to contact the solar module;
an actuator arm assembly comprising a pair of actuator arms which extend from the top hat assembly and which form an opening configured to receive a tubular member of the solar array; and
a fastener assembly comprising a first fastener and a second fastener and configured to connect the pair of actuator arms and secure the mounting bracket to both the solar module and the tubular member;
wherein the fastener assembly comprises an unlocked configuration in which the first fastener is loosened from the second fastener and the tubular member is permitted to enter into the opening, and a locked configuration which locks the solar module to the mounting bracket and the mounting bracket to the tubular member received in the opening in response to only mechanically moving the first fastener relative to the second fastener when the tubular member is received in the opening and the solar module is received in a receptacle formed between the first rail and the second rail .

11. The solar array of claim 10, wherein at least one of the first fastener and the second fastener is rotatable about a longitudinal axis of the first fastener when the first fastener is connected to the second fastener.

12. The solar array of claim 10, wherein the solar module is electrically grounded to the support structure when the fastener assembly is in the locked configuration with the tubular member received in the opening and the solar module received in the aperture.

13. The solar array of claim 10, wherein the first fastener is configured to displace the inner top hat relative to the outer top hat along the lateral axis when the tubular member is received in the opening in response to applying a rotational torque to one of the first fastener and the second fastener.

14. The solar array of claim 10, wherein each of the pair of actuator arms of the mounting bracket are pivotally coupled to the top hat assembly.

15. The solar array of claim 10, wherein:
relative movement along the lateral axis of the top hat assembly of the mounting bracket between the inner top hat and the pair of actuator arms is restricted; and
a predefined degree of relative movement along the lateral axis of the top hat assembly between the outer top hat and the pair of actuator arms is permitted.

16. The solar array of claim 10, wherein:
the first rail of the mounting bracket comprises a first contact surface configured to contact a first surface of the solar module, and the second rail comprises a second contact surface configured to contact an opposing second surface of the solar module; and
the first contact surface comprises a first edge formed thereon and configured to pierce the first surface of the solar module.

17. The solar array of claim 16, wherein the first contact surface and the second contact surface of the mounting bracket are each electrically conductive.

18. A method for coupling a solar module of a solar array to a support structure of the solar array, the method comprising:
(a) inserting a tubular member of the support structure into an opening formed between a pair of actuator arms of an actuator arm assembly of the mounting bracket;
(b) inserting the solar module into a receptacle formed between an outer top hat and an inner top hot of a top hat assembly of the mounting bracket; and
(c) mechanically moving only a first fastener relative to a second fastener of a fastener assembly of the mounting bracket whereby the inner top hat is displaced relative to the outer top hat along a lateral axis of the top hat assembly to both lock the top hat assembly to the solar module and lock the pair of actuator arms to the tubular member received in the opening.

19. The method of claim 18, wherein (c) comprises forming an electrical connection between the support structure and the solar array through the mounting bracket.

20. The method of claim 18, wherein (c) comprises applying a rotational torque to at least one of the first fastener and the second fastener to rotate at least one of the first fastener and the second fastener about a longitudinal axis of the first fastener.
